(19) United States
(12) Patent Application Publication
(10) Pub. No.: US 2023/0000130 A1
(43) Pub. Date: Jan. 5, 2023

(54) KIBBEH-MAKING ATTACHMENT FOR A STAND MIXER

(71) Applicant: Fakhoury Tech Investments LLC, Vancouver, WA (US)

(72) Inventors: Michael Fakhoury, Vancouver, WA (US); Ghada Chakour Fakhoury, Vancouver, WA (US); Omar J. Fakhoury, Vancouver, WA (US)

(21) Appl. No.: 17/856,510

(22) Filed: Jul. 1, 2022

Related U.S. Application Data
(60) Provisional application No. 63/218,217, filed on Jul. 2, 2021.

(51) Int. Cl. A23P 30/25; A47J 43/07; A23P 20/25

(52) U.S. Cl. CPC A23P 30/25; A47J 43/0705; A23P 20/25

(57) ABSTRACT

A countertop device for producing an extruded food product that includes a housing, an outer auger, an inner auger, and an extruder. The housing has a first inlet configured to permit shell material to be introduced into a conveyance chamber and a second inlet configured to permit filling material to be introduced into the conveyance chamber. The outer auger is configured to convey shell material from the first inlet to an outlet end of the conveyance chamber. The inner auger is concentric to the outer auger and is configured to convey filling material from the second inlet to an outlet end of the conveyance chamber. The extruder is at the outlet end of the conveyance chamber and is configured to shape filling material into the inner filling of the extruded food product and to shape shell material into the outer layer of the extruded food product.

### CROSS-REFERENCE TO RELATED APPLICATIONS

This application claims priority to U.S. provisional patent application No. 63/218,217, titled “Kibbeh-Making Attachment for a Stand Mixer,” filed Jul. 2, 2021, the disclosure of which is incorporated herein by reference in its entirety.

### TECHNICAL FIELD

The subject matter is related to an apparatus and methods for producing an extruded food product that has an outer layer surrounding an inner filling, and, more particularly, to an apparatus and methods for producing kibbeh.

### BACKGROUND

Kibbeh is a food that is typically comprised of an outside shell made from a raw mixture of bulgur and ground beef paste. The outside shell is stuffed with a cooked mixture of ground beef, onions, and pine nuts. The shell is then closed and formed, typically into a prolate spheroid (the shape of an American football). Typically, the stuffed and shaped shells are then fried in oil.

Generally, the shells are formed, filled, and shaped by hand. Accordingly, the mixture of bulgur and ground beef paste is first formed into a ball, and the cook then uses their thumb to shape the ball into a cup shape. That cup-shaped mixture is then filled by hand with the cooked filling, closed by hand, and then shaped by hand into the desired spheroid shape. This process must then be repeated for every kibbeh piece that the cook wishes to make.

While commercial kibbeh-making machinery is available, such machinery is too large, expensive, and complicated for typical home use.

Other devices suitable for home use only extrude the outer shell, leaving the cook to stuff the shell by hand.

Configurations of the disclosed technology address shortcomings in the prior art.

### BRIEF DESCRIPTION OF THE DRAWINGS

FIG. 1 is a perspective view of a kibbeh-making attachment, according to an example configuration, shown attached to an example stand mixer.

FIG. 2 is a perspective view of the kibbeh-making attachment of FIG. 1, illustrated without the stand mixer.

FIG. 3 is a perspective view of the kibbeh-making attachment of FIG. 2 in exploded view.

FIG. 4 is a sectional view of the kibbeh-making attachment, as defined in FIG. 2.

FIG. 5 is a perspective view of an example dual auger of the kibbeh-making attachment of FIG. 2.

FIG. 6 is an exploded view of the dual auger of FIG. 5.

FIG. 7 is a perspective view of an example of a kibbeh-making attachment, according to an example configuration, shown attached to a hand crank.

FIG. 8 is a sectional view of the kibbeh-making attachment, as defined in FIG. 7.

### DETAILED DESCRIPTION

As described here, aspects are directed to a kibbeh-making attachment for a stand mixer or other rotary power input such as an electric motor or hand crank. Configurations provide a kibbeh-making device that is small, affordable, and simple enough for typical home use, such as while resting on a countertop or tabletop, and that automatically stuffs the outer shell with the filling.

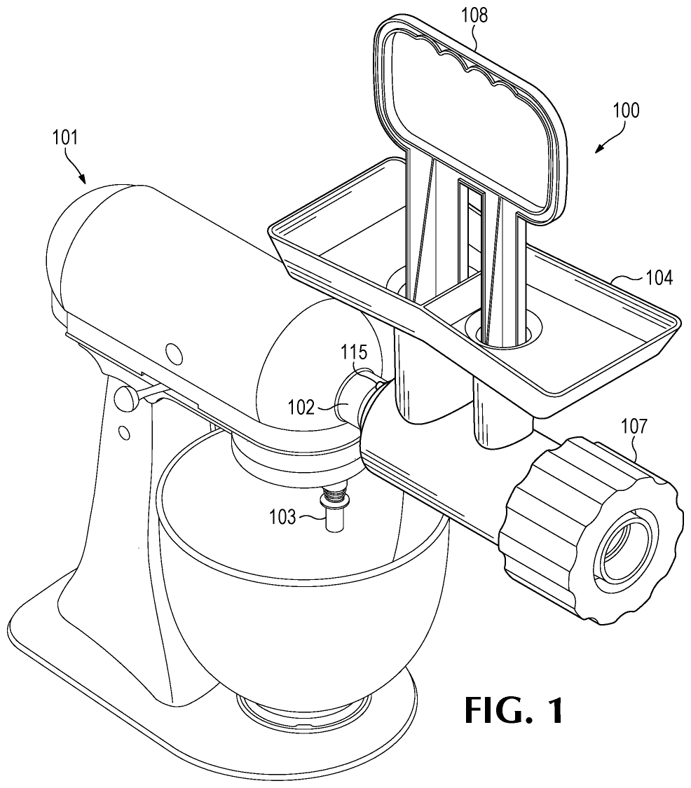

As illustrated in FIG. 1, in configurations a kibbeh-making attachment 100 may be attached to an auxiliary power output 102 of a stand mixer 101.

The stand mixer 101 could be any countertop-sized, stand mixer having an auxiliary power output 102 for mixer accessories. Such stand mixers are readily available to consumers and professional cooks. The auxiliary power output 102 is a rotational drive for the mixer accessories. In configurations, instead of the auxiliary power output 102, the kibbeh-making attachment 100 could be coupled to the primary 103 power output of the stand mixer 101. The primary 103 power output is the output that is usually vertical and that drives the implement, such as beaters, dough hooks, and whisks, in the mixing bowl of the stand mixer 101.

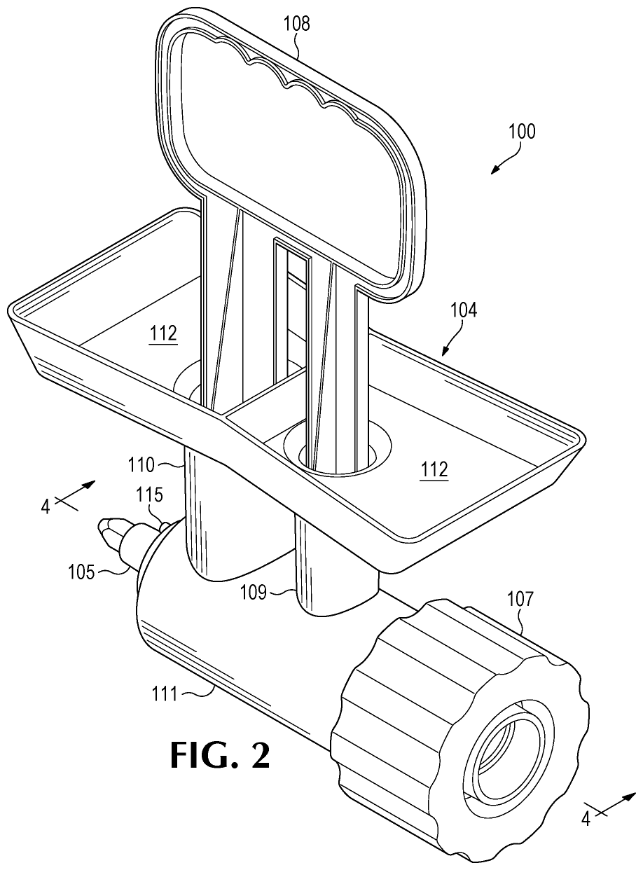

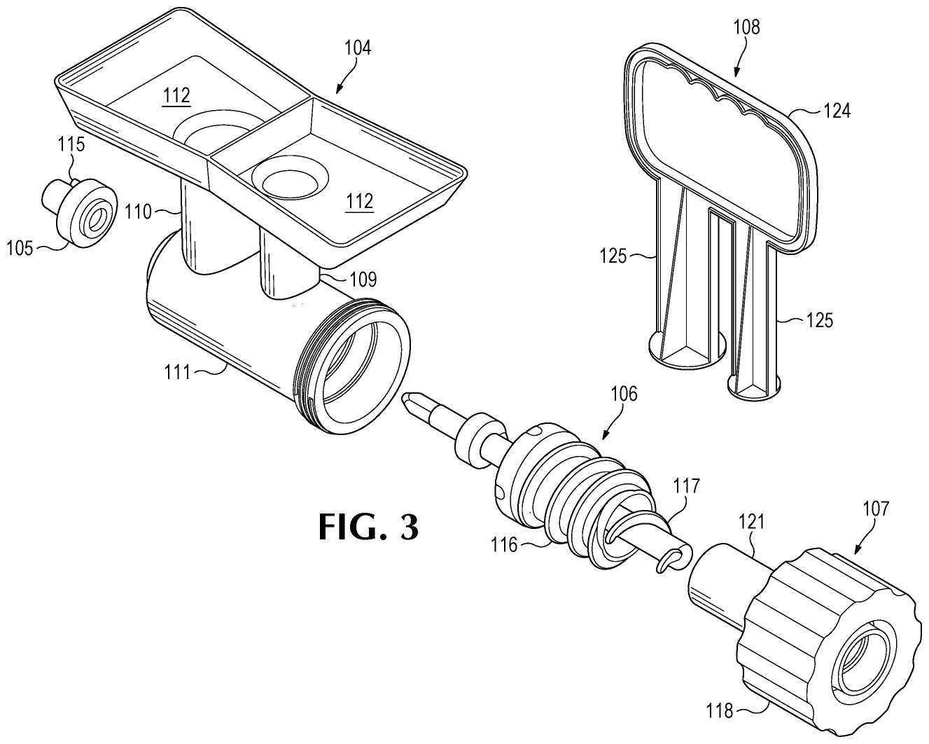

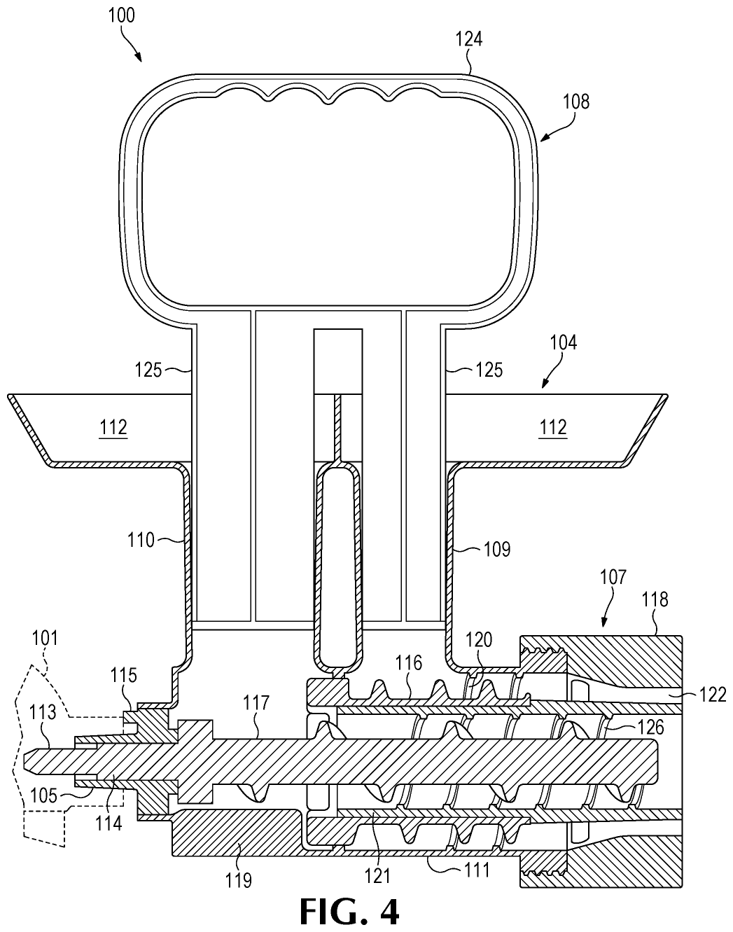

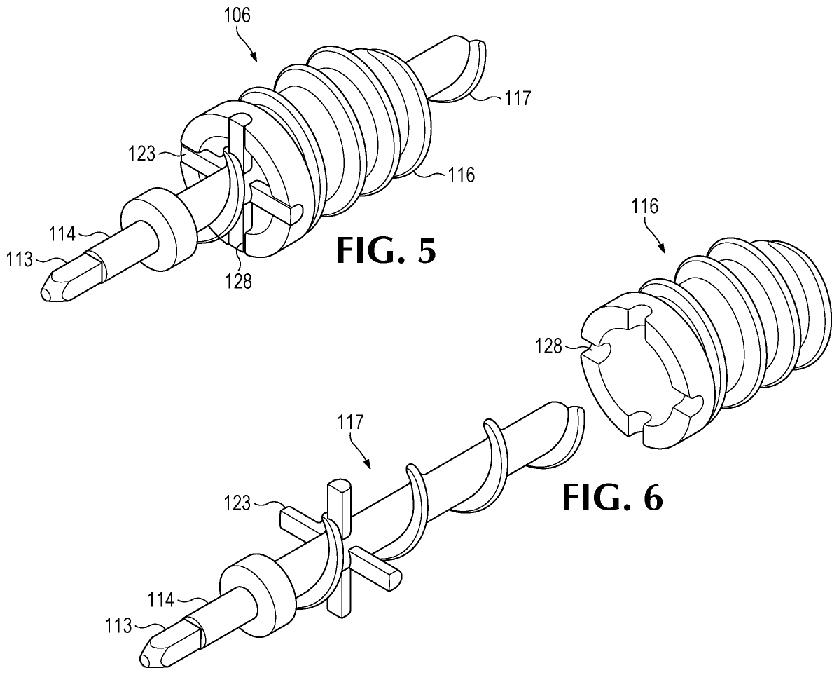

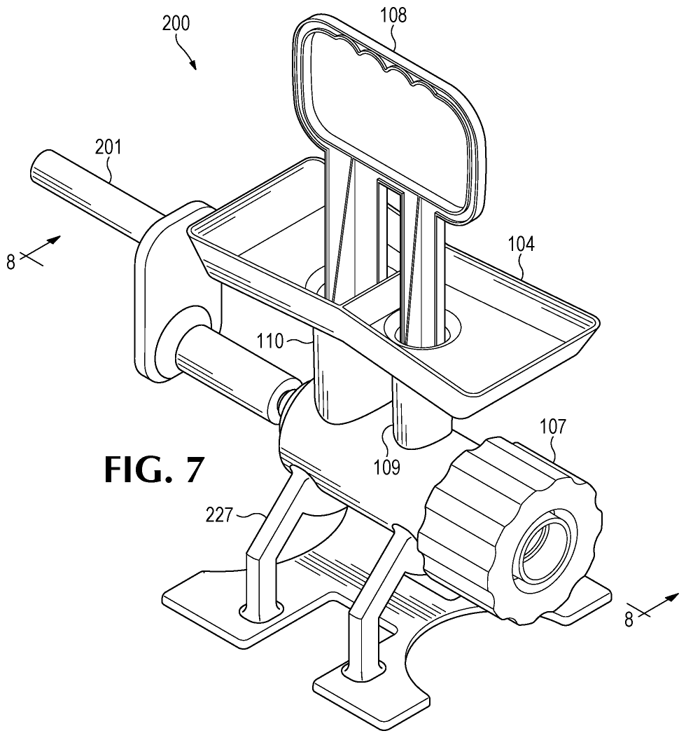

FIG. 2 is a perspective view of the kibbeh-making attachment of FIG. 1, illustrated without the stand mixer. FIG. 3 is a perspective view of the kibbeh-making attachment of FIG. 2 in exploded view. FIG. 4 is a sectional view of the kibbeh-making attachment, as defined in FIG. 2. FIG. 5 is a perspective view of an example dual auger of the kibbeh-making attachment of FIG. 2. FIG. 6 is an exploded view of the dual auger of FIG. 5.

As illustrated in FIGS. 2-6, the kibbeh-making attachment 100 may include a housing 104, a housing sleeve 105, a dual auger 106, an extruder cap 107, and a press handle 108. FIGS. 2-6 show generally how these components may be assembled together into the kibbeh-making attachment 100.

The housing 104 is configured to contain the housing sleeve 105, the dual auger 106, the extruder cap 107, and the press handle 108. The housing 104 may include a first chute 109, a second chute 110, and a conveyance chamber 111. The first chute 109 is configured to provide the shell material to the dual auger 106, as more fully described below. The shell material is the material for the outside shell of the kibbeh, which, as noted above, is often made from a raw mixture of bulgur and ground beef paste. The second chute 110 is configured to provide filling material to the dual auger 106, as more fully described below. The filling material is the material to be stuffed within the outside shell of the kibbeh. As noted above, the filling material is often made from a cooked mixture of ground beef, onions, and pine nuts. The conveyance chamber 111 is the chamber in which the shell material and the filling material are conveyed from the first chute 109 and the second chute 110 to the extruder cap 107, as more fully described below. In configurations, the conveyance chamber 111 may include a step 119 in a portion of the conveyance chamber 111 aligned with the second chute 110. The step 119 may help to prevent the filling material from becoming trapped within the conveyance chamber 111 out of reach of the dual auger 106. As best shown in FIG. 4, the step 119 occupies that portion of the conveyance chamber 111 where the outer auger 116 (discussed below) does not extend.

Each of the first chute 109 and the second chute 110 may include a hopper 112 to hold additional shell material and filling material. As illustrated, there may be a wall or other separator between the two hoppers 112 to avoid mixing of the filling material and the shell material within the hoppers 112.

The housing sleeve 105 is configured to substantially surround and support an attachment end 113 of a center beam 114 of the dual auger 106, allowing the center beam 114 to rotate within the housing sleeve 105. As used in this disclosure, “substantially surround” means largely or essentially extending around, without requiring perfect encircling. In configurations, the housing sleeve 105 is also configured to mate the kibbeh-making attachment 100 to the stand mixer 101. Accordingly, the housing sleeve 105 may include one or more protrusions 115, slots, or other features to interface with the particular stand mixer 101, as different stand mixers may require different interfaces.

In configurations, the kibbeh-making attachment 100 may include a converter or adaptor (not illustrated) to permit the kibbeh-making attachment 100 to be compatible with a variety of stand mixer styles.

As illustrated, the dual auger 106 has concentric augers: an outer auger 116 and an inner auger 117, each of which rotates about the center beam 114 of the dual auger 106. The attachment end 113 of the center beam 114 is configured to couple to the stand mixer 101. Hence, rotary motion and torque from the stand mixer 101 is transferred to the kibbeh-making attachment 100 by way of the attachment end 113 of the center beam 114. The center beam 114 is configured to spin about its longitudinal axis. The attachment end 113 may include features to interface with the particular stand mixer 101, as different stand mixers may require different interfaces.

The outer auger 116 is configured to convey shell material from the first chute 109 to an outlet end 118 of the extruder cap 107, the extruder cap 107 being at an outlet end of the conveyance chamber 111. To do so, the outer auger 116 spins about the center beam 114 and against the relatively fixed wall (i.e. one that does not spin with the center beam 114) of the conveyance chamber 111. The spinning action tends to push the shell material toward the outlet end 118 of the extruder cap 107. In configurations, the conveyance chamber 111 may include a reverse spline 120 on the interior wall of the conveyance chamber 111. The reverse spline 120 includes a helical wind direction that is opposite in direction to the helical wind direction of the outer auger 116 to promote movement of shell material within the conveyance chamber 111. For example, when the outer auger 116 is viewed from the attachment end 113 of the inner auger 117 as illustrated in FIGS. 5 and 6, the helical wind direction of the outer auger 116 is counterclockwise. Hence, from the same viewpoint, the helical wind direction of the reverse spline 120 is clockwise. As best shown in FIG. 4, the outer auger 116 does not extend beyond, and preferable does not substantially extend into, the path defined by the second chute 110. Accordingly, the outer auger 116 would not obstruct the passage of filling material from passing from the second chute 110 to the inner auger 117.

The inner auger 117 is configured to convey filling material from the second chute 110 to the outlet end 118 of the extruder cap 107. To do so, the inner auger 117 spins about the center beam 114 against the relatively fixed chamber extension 121 of the extruder cap 107 (i.e. the chamber extension 121 does not spin with the center beam 114). The spinning action tends to push the shell material toward the outlet end 118 of the extruder cap 107. In configurations, the extruder cap 107 may include a reverse spline 126 on the interior wall of the extruder cap 107. The reverse spline 126 includes a helical wind direction that is opposite in direction to the helical wind direction of the inner auger 117 to promote movement of filling material within the extruder cap 107, particularly the chamber extension 121 of the extruder cap 107. For example, when the inner auger 117 is viewed from the attachment end 113 as illustrated in FIGS. 5 and 6, the helical wind direction of the inner auger 117 is counterclockwise. Hence, from the same viewpoint, the helical wind direction of the reverse spline 126 is clockwise.

As most clearly illustrated in FIGS. 5 and 6, the inner auger 117 may include one or more drive extensions 123 to transfer rotational motion and torque of the inner auger 117 to the outer auger 116. In configurations, the outer auger 116 may include receptacles 128 to accept the drive extensions 123 of the inner auger 117 and to align the outer auger 116 to the inner auger 117 (both rotationally about the center beam 114 and longitudinally along the length of the inner auger 117).

As illustrated, the extruder cap 107 may include the chamber extension 121, the outlet end 118, and a converging chamber 122. The chamber extension 121 extends into the conveyance chamber 111, but typically not further than the inner auger 117 extends into the conveyance chamber 111 from the outlet end 118 of the extruder cap 107. Stated another way, the chamber extension 121 extends into the conveyance chamber 111 to a point that is between the first chute 109 and the second chute 110. The chamber extension 121 provides a relatively fixed surface (one that does not spin about the center beam 114) against which the inner auger 117 may rotate to convey the filling material. As illustrated, the chamber extension 121 may have the form of a right cylinder.

The converging chamber 122 is configured to gather, compress, and shape the shell material before the shell material leaves the extruder cap 107. The filling material and the shell material pass through the outlet end to exit the extruder cap 107. In configurations, the converging chamber 122 also helps ensure a homogeneous mass flow rate during shell extrusion. In configurations, the converging chamber 122 also reduces the diameter of the shell material, so that the diameter of the shell material, upon leaving the extruder cap 107, is close to the outer diameter of the filling material upon leaving the extruder cap 107. In different configurations, the shell outlet sizing can be made smaller or larger to produce a desired kibbeh shell wall thickness depending on preferences of the consumer. In configurations, the extruder cap 107 is threaded to the housing 104. In such configurations, the direction to tighten the extruder cap 107 onto the housing 104 via the threads is preferably the same direction that the dual auger 106 spins during normal operation to prevent the extruder cap 107 from loosening during normal operation.

As illustrated, the press handle 108 is configured to simultaneously push shell material through the first chute 109 and filling material through the second chute 110. In the illustrated configuration, the press handle 108 includes a single handle 124 and two plungers 125 extending from the single handle 108. In configurations, the two plungers 125 may have different lengths. Such configurations may be useful, for example, to create a lag between the extrusion of the shell material and the extrusion of the filling material. Hence, if it is desired that the shell material begin extruding before the filling material, the plunger 125 that corresponds to the first chute 109 may be longer than the plunger 125 that corresponds to the second chute 110.

Each of the components discussed above may be made from, for example, food grade plastic, although other materials could be used in configurations.

As noted, configurations provide a kibbeh-making device that is simple enough for typical home use, such as while resting on a countertop or tabletop. In that regard, the weight of the kibbeh-making device preferably does not exceed ten pounds (4.5 kilograms). More preferably, the weight of the kibbeh-making device preferably does not exceed 7.5 pounds (3.4 kilograms). Even more preferably, the weight of the kibbeh-making device preferably does not exceed five pounds (2.3 kilograms). In addition, the kibbeh-making device, when assembled as shown in FIG. 2, preferably would fit entirely within a box having a volume of 6000 cubic inches (0.09832 cubic meters). This concept of fitting entirely within a box having a given volume is referred to in this disclosure at the “cube size.” More preferably, the kibbeh-making device preferably would have a cube size that does not exceed 3500 cubic inches (0.05735 cubic meters). Even more preferably, the kibbeh-making device preferably would have a cube size that does not exceed 1000 cubic inches (0.01639 cubic meters). Accordingly, the kibbeh-making device is small enough (in both weight and size) for a typical human user to be able to move the kibbeh-making device by hand from place to place.

To use the illustrated configuration of the kibbeh-making attachment 100 illustrated in FIGS. 1-6, a user would connect the kibbeh-making attachment 100 to a stand mixer 101.

Next, the user would insert shell material into the first chute 109 (and perhaps the hopper 112 corresponding to the first chute 109) and filling material into the second chute 110 (and perhaps the hopper 112 corresponding to the second chute 110). The user would then insert the press handle 108, inserting one of the two plungers 125 into the first chute 109 and the other of the two plungers 125 into the second chute 110.

While maintaining some pressure on the press handle 108 (to ensure a constant supply of the shell material and the filling material to the conveyance chamber 111), the user may turn on the stand mixer 101 to provide rotation to the center beam 114 of the dual auger 106.

When activated, the dual auger 106 conveys the shell material through the conveyance chamber 111 by way of the outer auger 116, and the dual auger 106 conveys the filling material through the conveyance chamber 111 by way of the inner auger 117. The shell material then passes through the converging chamber 122 and out the outlet end 118 of the extruder cap 107. The filling material passes through the extruder cap 107 and out the outlet end 118 of the extruder cap 107.

By exiting the extruder cap 107 at the same time, the shell material surrounds the filling material, forming an extrusion with shell material on the outside and filling material on the inside. The user may then clip the extruded material to a desired length, pinch the shell material closed on each end, and form the kibbeh piece.

The process may continue until the desired number of kibbeh pieces are obtained.

While the device has been described as a kibbeh-making attachment, the disclosed concepts could be applied to make products other than kibbeh, including other food products that have an outer layer surrounding an inner filling.

In addition, while the discussion above focuses on using a stand mixer, other mechanical input methods and apparatus could be used to provide rotational energy to drive the kibbeh-making attachment. For example, in configurations the kibbeh-making attachment may be driven instead by another electric motor or by a manual crank configured to rotate the center beam 114 of the dual auger 106.

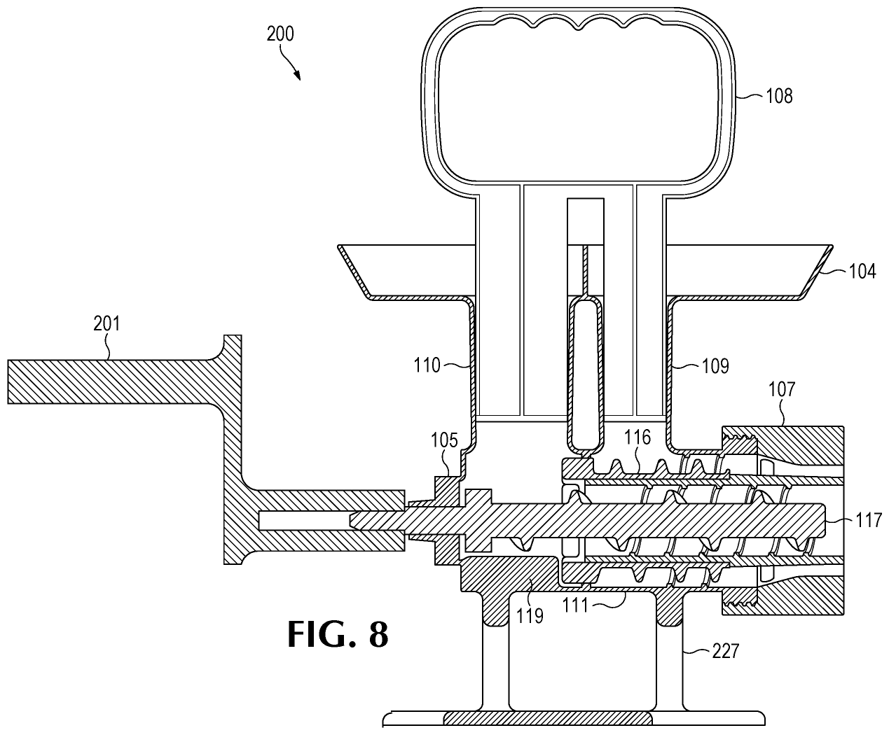

In that regard, FIG. 7 is a perspective view of an example of a kibbeh-making attachment, according to an example configuration, shown attached to a hand crank. FIG. 8 is a sectional view of the kibbeh-making attachment, as defined in FIG. 7. As illustrated in FIGS. 7 and 8, the kibbeh-making attachment 200 may include a hand crank 201 configured to rotate the center beam 114 of the dual auger 106. In addition, the kibbeh-making attachment 200 may include a support stand 227 to support the housing 104, for example, on a countertop or other similar surface. Otherwise, the kibbeh-making attachment 200 of FIGS. 7-8 may have the same features as described above for the kibbeh-making attachment 100 of FIGS. 1-6.

### EXAMPLES

Illustrative examples of the disclosed technologies are provided below. A particular configuration of the technologies may include one or more, and any combination of, the examples described below.

Example 1 includes a device for producing an extruded food product having an outer layer surrounding an inner filling, the device comprising: a housing having a first inlet, a second inlet, and a conveyance chamber, the first inlet being configured to permit shell material to be introduced into the conveyance chamber for forming into the outer layer of the extruded food product, the second inlet being configured to permit filling material to be introduced into the conveyance chamber for forming into the inner filling of the extruded food product; an outer auger within the housing and configured to convey shell material, when introduced into the conveyance chamber, from the first inlet to an outlet end of the conveyance chamber; an inner auger within the housing and concentric to the outer auger, the inner auger configured to convey filling material, when introduced into the conveyance chamber, from the second inlet to an outlet end of the conveyance chamber; and an extruder at the outlet end of the conveyance chamber and configured to shape filling material exiting the conveyance chamber into the inner filling of the extruded food product and to shape shell material exiting the conveyance chamber into the outer layer of the extruded food product.

Example 2 includes the device of Example 1, the extruder further having a chamber extension extending from an outlet end of the extruder and into the conveyance chamber, between the inner auger and the outer auger, the chamber extension providing a relatively fixed surface against which the inner auger rotates.

Example 3 includes the device of Example 2, in which the chamber extension extends into the conveyance chamber to a point between the first inlet and the second inlet.

Example 4 includes the device of any of Examples 2-3, in which the chamber extension comprises a reverse spline on the surface of the chamber extension, the reverse spline having a helical wind direction that is opposite a helical wind direction of the inner auger.

Example 5 includes the device of any of Examples 1-4, the extruder further having a converging chamber configured to gather, compress, and shape shell material as shell material passes through the converging chamber.

Example 6 includes the device of any of Examples 1-5, in which the conveyance chamber further comprises a reverse spline on a surface of the conveyance chamber substantially surrounding the outer auger, the reverse spline having a helical wind direction that is opposite a helical wind direction of the outer auger.

Example 7 includes the device of any of Examples 1-6, in which the conveyance chamber further comprises a step substantially aligned with the second inlet, the step narrowing the conveyance chamber and configured to prevent filling material from becoming trapped within the conveyance chamber.

Example 8 includes the device of any of Examples 1-7, in which the inner auger further comprises one or more drive extensions configured to transfer rotational motion of the inner auger to the outer auger, each of the one or more drive extensions extending radially from a center beam of the inner auger.

Example 9 includes the device of Example 8, in which the outer auger further comprises one or more receptacles to accept the one or more drive extensions and to align the outer auger to the inner auger.

Example 10 includes the device of any of Examples 1-9, in which the first inlet comprises a first chute; in which the second inlet comprises a second chute; and in which the device further comprises a press handle configured to simultaneously push shell material through the first chute toward the conveyance chamber and filling material through the second chute toward the conveyance chamber.

Example 11 includes the device of any of Examples 1-10, in which the inner auger further comprises an attachment end configured to couple to, and receive rotational motion from, a stand mixer.

Example 12 includes the device of any of Examples 1-10, in which the inner auger further comprises an attachment end configured to couple to, and receive rotational motion from, a hand crank.

Example 13 includes the device of any of Examples 1-10, in which the inner auger further comprises an attachment end configured to couple to, and receive rotational motion from, an electric motor.

Example 14 includes the device of any of Examples 1-13, the device having a weight that does not exceed ten pounds (4.5 kilograms).

Example 15 includes the device of any of Examples 1-14, the device having a cube size that does not exceed 6000 cubic inches (0.09832 cubic meters).

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method or process having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

In addition, directions such as “vertical,” “horizontal,” “right,” and “left” are used for convenience and in reference to the views provided in figures. But the kibbeh-making attachment may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

What is claimed is:

1. A device for producing an extruded food product having an outer layer surrounding an inner filling, the device comprising:
a housing having a first inlet, a second inlet, and a conveyance chamber, the first inlet being configured to permit shell material to be introduced into the conveyance chamber for forming into the outer layer of the extruded food product, the second inlet being configured to permit filling material to be introduced into the conveyance chamber for forming into the inner filling of the extruded food product;
an outer auger within the housing and configured to convey shell material, when introduced into the conveyance chamber, from the first inlet to an outlet end of the conveyance chamber;
an inner auger within the housing and concentric to the outer auger, the inner auger configured to convey filling material, when introduced into the conveyance chamber, from the second inlet to an outlet end of the conveyance chamber; and
an extruder at the outlet end of the conveyance chamber and configured to shape filling material exiting the conveyance chamber into the inner filling of the extruded food product and to shape shell material exiting the conveyance chamber into the outer layer of the extruded food product.

2. The device of claim 1, the extruder further having a chamber extension extending from an outlet end of the extruder and into the conveyance chamber, between the inner auger and the outer auger, the chamber extension providing a relatively fixed surface against which the inner auger rotates.

3. The device of claim 2, in which the chamber extension extends into the conveyance chamber to a point between the first inlet and the second inlet.

4. The device of claim 2, in which the chamber extension comprises a reverse spline on the surface of the chamber extension, the reverse spline having a helical wind direction that is opposite a helical wind direction of the inner auger.

5. The device of claim 1, the extruder further having a converging chamber configured to gather, compress, and shape shell material as shell material passes through the converging chamber.

6. The device of claim 1, in which the conveyance chamber further comprises a reverse spline on a surface of the conveyance chamber substantially surrounding the outer auger, the reverse spline having a helical wind direction that is opposite a helical wind direction of the outer auger.

7. The device of claim 1, in which the conveyance chamber further comprises a step substantially aligned with the second inlet, the step narrowing the conveyance chamber and configured to prevent filling material from becoming trapped within the conveyance chamber.

8. The device of claim 1, in which the inner auger further comprises one or more drive extensions configured to transfer rotational motion of the inner auger to the outer auger, each of the one or more drive extensions extending radially from a center beam of the inner auger.

9. The device of claim 8, in which the outer auger further comprises one or more receptacles to accept the one or more drive extensions and to align the outer auger to the inner auger.

10. The device of claim 1, in which the first inlet comprises a first chute; in which the second inlet comprises a second chute; and in which the device further comprises a press handle configured to simultaneously push shell material through the first chute toward the conveyance chamber and filling material through the second chute toward the conveyance chamber.

11. The device of claim 1, in which the inner auger further comprises an attachment end configured to couple to, and receive rotational motion from, a stand mixer.

12. The device of claim 1, in which the inner auger further comprises an attachment end configured to couple to, and receive rotational motion from, a hand crank.

13. The device of claim 1, in which the inner auger further comprises an attachment end configured to couple to, and receive rotational motion from, an electric motor.

14. The device of claim 1, the device having a weight that does not exceed ten pounds (4.5 kilograms).

15. The device of claim 1, the device having a cube size that does not exceed 6000 cubic inches (0.09832 cubic meters).
